(19) United States
(12) Patent Application Publication
(10) Pub. No.: US 2008/0267063 A1
(43) Pub. Date: Oct. 30, 2008

(54) Method and apparatus for multi-user scheduling for interference avoidance in adaptive beamforming systems

(75) Inventors: Hafedh Trigui, Ottawa (CA); Kathryn Adeney, Dunrobin (CA); Chris Ward, Hertfordshire (GB); Keith Wilson, Bangkok (TH)

Correspondence Address: Lawrence G. Kurland, Esq.;BRYAN CAVE LLP, 1290 Avenue of the Americas, New York, NY, 10104-3300, US

(73) Assignee: TenXc Wireless, Inc.

(21) Appl. No.: 11/796,378

(22) Filed: Apr. 27, 2007

(51) Int. Cl. H04J 1/00

(52) U.S. Cl. 370/229

(57) ABSTRACT

A method and apparatus of imparting coverage gain to cell-edge or cusp mobile subscribers without resort to diluted frequency reuse factors is disclosed. Each base station adopts a priori a beam illumination sequence designed to minimize or obviate the likelihood of beam clashes in a narrow beam adaptive beamforming system. Such sequences may be optimized to impact primarily cell-edge subscribers or subscribers within cusp areas of adjoining beams or sectors. The inventive protocols may be applicable to fixed multibeam systems as well as individual steered beam and spatial null generation antenna systems.

### BACKGROUND OF THE INVENTION

### Field of the Invention

The present invention relates to adaptive beamforming systems and more particularly to a novel method and apparatus of interference avoidance using multi-user scheduling.

A key performance metric of a wireless mobile access network is the ability of a system to deliver acceptable data rates over a given percentage of the network coverage area. Coverage performance is usually achieved by appropriate link budget design and the provision of effective interference mitigation features in the system design.

New broadband systems such as WiMAX (Worldwide Interoperability for Microwave Access) incorporate many features such as OFDMA (Orthogonal Frequency Division Multiplex Access), adaptive coding and modulation and MIMO (multiple input multiple output), aimed at maximizing spectral efficiency. However, such systems typically suffer from a coverage issue whereby very high data rates may only be supported across a small portion of the cell's service area unless the spectral efficiency of the network is penalized.

In an interference-limited system utilizing unity (N= 1/1) frequency reuse, all of the available frequencies are used by every cell and sector in the network. With a network deploying conventional sectorized antennas, coverage issues are particularly identified for a subscriber at the cell edge, that is, the far extremity of the cell area serviced by the serving base station with which the subscriber is associated. In such a situation, interference from a base station in an adjoining cell will be a similar distance away from the subscriber that is comparable to the distance between the serving base station and the subscriber. Accordingly, the interfering signal may be received at a level comparable with that of the desired signal. As a result, link throughput may be significantly compromised.

Fairness control in the scheduler design, for example, the fairness exponent factor in the generic Proportional Fair scheduler, may help coverage problems by devoting more resources to mobiles operating under poor SNIR (signal to noise plus interference ratio) conditions, but the result is invariably a much poorer cell capacity, which reduces the overall spectral efficiency of the network.

Another means whereby the network may improve edge of cell coverage is to use a relaxed frequency reuse plan, in which all sectors or cells do not use the same frequency spectrum. For example, currently proposed WiMAX networks tend to use a frequency reuse factor, such as N=⅓, in which cells or sectors within a cell are allocated only ⅓ of the available frequencies, typically in some sort of ordering to minimize interference between adjoining cells. Alternatively, the system could partially load the carriers to achieve the same end. However, such approaches suffer from a three-fold spectral resource penalty in order to overcome the cell edge interference problem.

Directional beam antennas or adaptive beamforming have been proposed as possible solutions to the coverage problem identified above, as the narrower geographical extent of the beams provided is such that there will be a lower probability that interference will be received from other cells in the network. Nevertheless, with randomized beam scheduling in the different cells of the network, there still remains a finite possibility for beam clashes, where a mobile being served by a particular beam in one cell will encounter unintentional interference from a beam in the adjacent cell, which just happens to be pointed to it.

What is therefore needed is a method and apparatus that substantially dispenses with any finite probability of beam clashes, even in an environment of full load or unity frequency reuse.

### SUMMARY OF INVENTION

The present invention provides a coverage enhancement solution for broadband wireless mobile access networks. High traffic loading and full (N= 1/1) frequency reuse cause high levels of intra-cell and inter-cell co-channel interference that limits the coverage area over which high data rates may be supported. Interference mitigation is provided by the use of directional beam antennas. The inventive novel scheduler design assists in avoiding interference and provides improved coverage/capacity performance within the network when such directional antennas are deployed in the system.

Improved interference avoidance performance could be achieved by coordinating the scheduling on beams across the network so that the likelihood of beam clashes between adjacent cells or sectors is minimized at any given scheduling instant.

Typically, such scheduling may be established at the time of network set-up, thus obviating any inter-cell communication. The present beam scheduling method assumes that the cells operate using a synchronized frame structure.

No significant capacity constraint is imposed by the present invention, as the same number of mobile subscribers may be served by each transmit frame. However, intelligent scheduling, as proposed in the present invention, permits any statistical probability of beam clash using directional beams to be minimized, resulting in improved SNIR performance and potentially greater spectral efficiency from resumption of full frequency reuse.

An initial approach to the inventive intelligent scheduling involves the use of fixed directional beams. However, the inventive concept may be easily extended to more advanced beamforming concepts including the use of agile beams and spatial null generation for improved SNIR performance.

Additionally, the inventive concept may be further extended to include limited schedule coordination, whether through the base station controller in more established beamforming systems, or by taking advantage of integrated base station scheduling features of third and fourth generation systems.

According to a first broad aspect of an embodiment of the present invention, there is disclosed a method of avoiding beam clashes at a mobile subscriber, between a desired directional beam emanating from a base station associated with the mobile subscriber, along which communications between the mobile subscriber and the associated base station extend, and an interfering directional beam, the method comprising the steps of: allocating all communications between the associated base station and the mobile subscriber along the desired directional beam to a first time interval; and allocating all communications along the interfering directional beam to a second time interval that is different from the first time interval.

According to a second broad aspect of an embodiment of the present invention, there is disclosed a system for avoiding beam clashes at a mobile subscriber, between a desired directional beam and an interfering directional beam, the system comprising: a base station associated with the mobile subscriber, for generating a plurality of directional beams across a desired coverage area of the associated base station, including the desired directional beam, along which communications with the mobile subscriber extend, the associated base station comprising a desired beam scheduler for allocating all communications involving the associated base station along each of the plurality of directional beams to a corresponding time interval, wherein all communications between the associated base station and the mobile subscriber along the desired directional beam occurs during a first time interval and all communications along the interfering directional beam occurs during a second time interval that is different from the first time interval.

According to a third broad aspect of an embodiment of the present invention, there is disclosed a scheduler operatively coupled to a base station adapted for communicating with a mobile subscriber, the scheduler for allocating all communications between the base station and the mobile subscriber along a desired directional beam emanating from the base station to a first time interval, whereby the communications between the mobile subscriber and the base station along the desired directional beam will be free from interference with communications emanating along an interfering directional beam which are restricted to a second time interval that is different from the first time interval.

According to a fourth broad aspect of an embodiment of the present invention, there is disclosed a computer-readable medium in a processor operatively coupled to a base station adapted for communicating with a mobile subscriber, the medium having stored thereon, computer-readable and computer-executable instructions which, when executed by the processor, cause the processor to allocate all communications between the base station and the mobile subscriber along a desired directional beam emanating from the base station to a first time interval, whereby the communications between the mobile subscriber and the base station along the desired directional beam will be free from interference with communications emanating along an interfering directional beam which are restricted to a second time interval that is different from the first time interval.

### BRIEF DESCRIPTION OF THE SEVERAL VIEWS OF THE DRAWING(S)

The embodiments of the present invention will now be described by reference to the following figures, in which identical reference numerals in different figures indicate identical elements and in which:

FIG. 1 shows a block diagram of two adjacent cells each with a pair of narrow beams that follow an illumination schedule according to an embodiment of the present invention;

FIG. 2 shows a block diagram of the two adjacent cells of FIG. 1, with a larger plurality of narrow beams;

FIG. 3 shows a prior art diagram showing how the internal scheduler of a base station would allocate resources in the case of a conventional sector with a switched multibeam configuration, but in the absence of the inventive system;

FIG. 4 shows a diagram corresponding to FIG. 3, showing how the internal scheduler of a base station would allocate resources in the case of the sector of FIG. 3, if it incorporated an embodiment of the present invention;

FIG. 5 shows an exemplary frequency band distribution pattern for a baseline N=⅓ sequential frequency reuse pattern system;

FIG. 6 shows a plot of performance cumulative distribution function as a function of SNIR of a simulation conducted on the exemplary baseline system of FIG. 5;

FIG. 7 shows a first exemplary random scheduling protocol for a notional full frequency reuse pattern system employing five directional beams;

FIG. 8 shows a plot of performance cumulative distribution function as a function of SNIR of a simulation conducted on the exemplary random scheduling system of FIG. 7;

FIG. 9 shows a second exemplary symmetric scheduling protocol in accordance with an embodiment of the present invention for a notional full frequency reuse pattern system employing five directional beams;

FIG. 10 shows a plot of performance cumulative distribution function as a function of SNIR of a simulation conducted on the exemplary symmetric scheduling system of FIG. 9;

FIG. 11 shows a third exemplary optimized scheduling protocol in accordance with an embodiment of the present invention for a notional full frequency reuse pattern system employing five directional beams;

FIG. 12 shows a plot of performance cumulative distribution function as a function of SNIR of a simulation conducted on the exemplary optimized scheduling system of FIG. 11;

FIG. 13 shows a plot of the composite performance cumulative distribution functions of FIGS. 7, 9 and 11 as a function of SNIR;

FIG. 14 shows an exemplary illustration of the application of an embodiment of the present invention as employed between corresponding outer beams or adjacent sectors of a common base station;

FIG. 15 shows an exemplary beam pattern distribution for a network employing three fixed beams per sector in accordance with the embodiment of FIG. 14; and

FIG. 16 shows an exemplary illustration of the application of an embodiment of the present invention as employed between corresponding outer beams or adjacent sectors of a common base station using spatial null steering.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

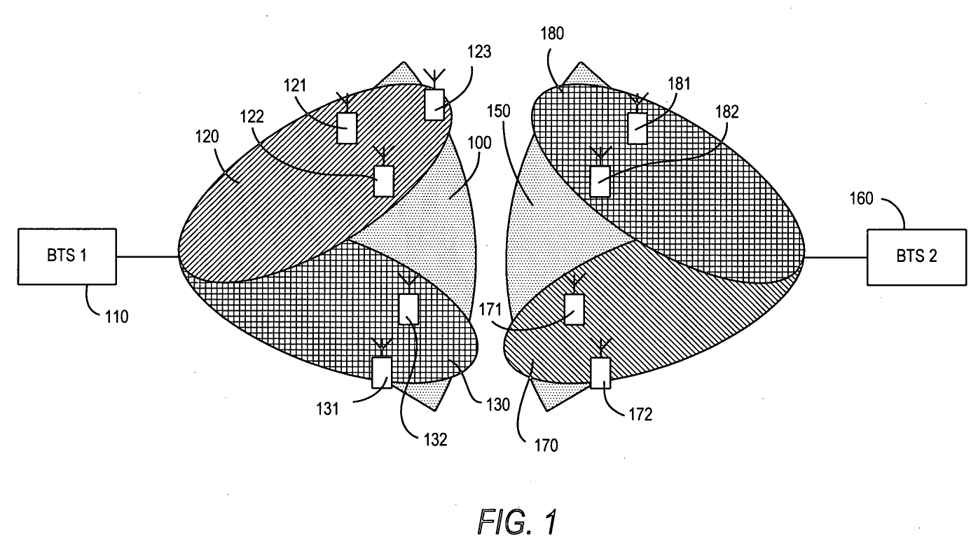

Referring to FIG. 1, there is shown a block diagram illustrating two adjacent cells 100, 150, each serviced by a base station 110, 160 implementing adaptive beamforming. In the example shown, each cell generates two fixed beams 120, 130, and 170, 180 respectively, each covering approximately half of the cell area.

Those having ordinary skill in this art will appreciate that the exemplary scenario shown in FIG. 1 could be applied to a mobile WiMAX network implementation. WiMAX is a new wireless system based on the IEEE 802.16e standard. It is the first standard using an OFDMA and MIMO on the air interface. Those having ordinary skill in this art will appreciate that other, currently less developed technologies include 3GPP LTE, IEEE 802.16m or CDMA2000 Rev. C.

WiMAX incorporates a combination of many features to achieve high spectral efficiency. OFDM technology offers the benefits of efficient implementation of modulation/demodulation, simple frequency domain equalization and frequency diversity of the multipath channel by coding and interleaving the information bits across the sub-carriers prior to transmission.

Further, fast C/I reporting by the mobiles facilitate the use of efficient link adaptation such as adaptive modulation and coding along both the uplink and downlink directions. Multiple antenna technology in the form of MIMO processing provides a means for enhanced link throughputs by capitalizing on the inherent parallelism within a multipath rich RF propagation channel, for example spatial multiplexing.

Initial WiMAX deployments are expected to be in Time Division Duplex (TDD) mode, in which the frame structure is split into a downlink (DL) sub-frame followed by an uplink (UL) sub-frame, with guard periods between the sub-frames and before a subsequent downlink sub-frame. A sub-frame may be split into zones, in order to accommodate multiple operation modes, each spanning the full amount of available spectrum and a portion of the total sub-frame duration.

Other WIMAX features include fast MAC scheduling, which is provided in order to cope with different QoS criteria for various supported services, an uplink and downlink scheduler within each base station, to ensure fast response to traffic demands and time-varying wireless channels, orthogonal sub-channels to reduce intra-cell multiple access interference, dynamic resource allocation for extra datalink robustness, at least in theory, through better fading and possible co-channel interference averaging, and frequency selective scheduling to enhance the overall capacity of the system.

Additionally, WiMAX has a zone switching feature that makes use of a scheduling process within each base station in the network and that allows different portions of the downlink or uplink sub-frame to operate on either of an N= 1/1 full load or unity reuse pattern, or an N=⅓ reuse pattern. Typically, mobiles with good SNIR operate in the N= 1/1 reuse zone, whereas mobiles located in cell edge positions may operate in the N=⅓ zone and accordingly take advantage of improved SNIR conditions. However, in so doing, the spectral efficiency of the network is correspondingly compromised.

One of the issues for future WiMAX networks is the trade-off between spectral efficiency and the provision of reasonable user data rates, especially at the cell edge. Maximum spectral efficiency may be achieved by full load or unity frequency reuse (N= 1/1).

On the other hand, subscribers closer to the cell edges are more likely to suffer from severe interference from adjacent sectors in the forward or downlink direction as well as substantial co-channel reverse or uplink interference from other mobiles who are close to cell edges in their respective serving sectors. When such interference is high, the serving base station's capacity and throughput will be severely degraded because the deployment of spatial multiplexing in such a scenario is unlikely and channel estimation will be compromised, resulting in higher error rates and consequentially reduced throughput.

Antenna beamforming at the serving base station makes use of narrow directional beams to help improve SNIR performance. This is highly desirable in order to maximize the network's spectral efficiency, to help overcome problems associated with adverse cell-edge SNIR and to maximize spatial multiplexing usage for rich propagation environments and full frequency reuse load.

The gains in SNIR performance are achieved by reducing the probability of receiving interference at the subscriber in the downlink direction from other base stations and by reducing the probability of receiving interference from co-channel mobiles served by other cells in the uplink direction.

As a general rule, the improvement in the SNIR is related to the ratio of the beamwidth of the narrow beams relative to the beamwidth (typically 65°) of the baseline sector antenna.

The provision of directional beams provides an additional dimension to the functionality of the WiMAX scheduler, in that each transmit sub-frame may be divided into a number of segments, each corresponding to a specified number of consecutive OFDMA symbols spanning part or all of the available spectrum for the sector, and only mobiles located within a particular beam, or within a range of beam pointing angles, may be assigned resources within each segment. Thus, each segment comprises a number of scheduling instances assigned to a portion of the overall cell coverage area.

In FIG. 1, we consider the simplest beamforming scheme, which is switched multibeam, in which the best beam from a predetermined and generally fixed set of beams is selected. For example, beams 120 and 130 are generated for cell 100 by base station 110.

As discussed below, the present invention may be extended for application to more complicated schemes, such as adaptive/steered beam schemes, in which an individually tailored beam is steered toward each active user and null-steering, in which a null is generated in the direction of identified co-channel interferers.

In FIG. 1, the internal scheduler for each base station 110, 160 maintains a simple preset sequencing arrangement, which is simply that the beams denoted by a striped pattern, namely beam 120 for BTS 1 110 and beam 170 for BTS 2 160 are illuminated during a first scheduling interval, while the beams denoted by a speckled pattern, namely beam 130 for BTS 1 110 and beam 180 for BTS 2 160 are illuminated during a second scheduling interval. For each base station, the internal scheduler simply alternates between the first and second scheduling intervals.

In such fashion, without any communication between base station 110 and 160, and only perfunctory synchronization, beams 120 and 180 would never be simultaneously illuminated. Indeed, the WiMAX standard already provides for accurate time synchronization between base stations, in order to support TDD operation.

This scheduling system has relatively little impact on subscribers that lie well within the cell boundary, such as subscribers 121, 122, 131, 132, 171, 172, 181 and 182, as the downlink signals they receive from their serving base station will typically be significantly stronger than the signals that they might receive from the other, non-serving base station, based simply on their respective distances from each base station. In conventional wireless networks, including WiMAX systems, beams are illuminated for certain time periods, so that the scheduling described herein is relatively transparent to each subscriber and for these subscribers, relatively innocuous.

With respect to subscriber 123, however, which lies at or near the cell edge boundary of beam 120, the scheduling described provides a significant SNIR performance advantage, while still remaining relatively transparent with respect to the subscriber. Such performance advantage lies in the fact that any statistical probability of a beam clash, even in a full load or unity frequency reuse situation is obviated because when beam 120 is illuminated, beam 180 is not, so that there is substantially reduced downlink co-channel interference.

Thus, one would expect to see an improvement in aggregate capacity across the network, consistent with the reduction in beamwidths (as discussed previously), as well as an improvement at the tail of an SNIR distribution curve due to the consequent reduction in neighbour cell interference due to random beam clashes.

FIG. 1 serves well to illustrate the inventive concept for a limited set of two base stations, but does not in itself represent a viable configuration. The simple beam allocation pattern implemented by the base station scheduler processes as shown in FIG. 1 would not successfully tessellate across a multi-cell network. Accordingly, the pattern shown in FIG. 1 is said to be unfair across the network.

The challenge is to construct a suitable set of beam sequences so as to maximize the interference reduction benefit from intelligent scheduling across the wider network. Such a set of sequences would be said to be fair across the network.

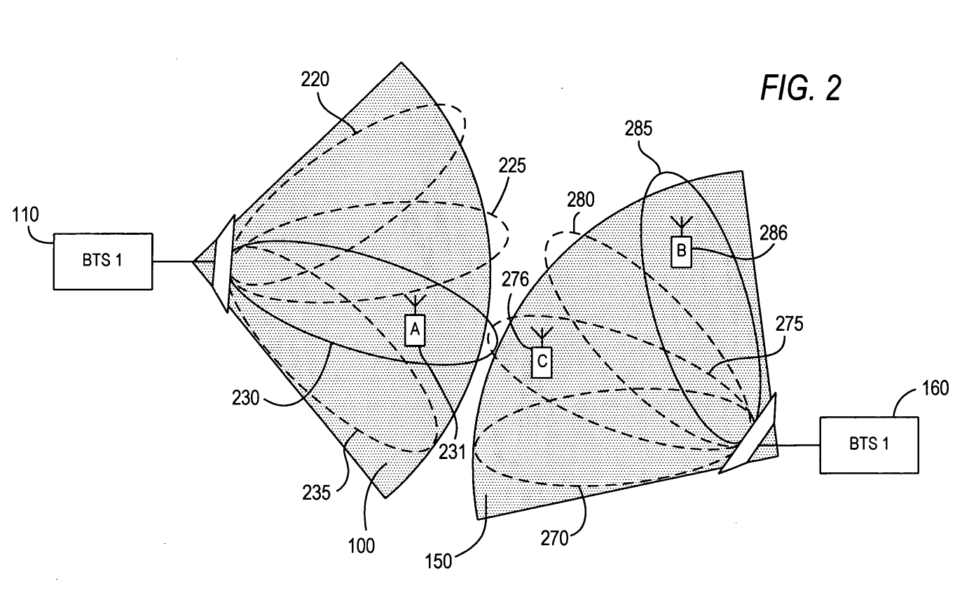

Turning now to FIG. 2, the concept introduced in FIG. 1 is extended to a switched multibeam or grid of beams arrangement, of more than two beams. In this case, each base station 110, 160 has associated with it, four beams, respectively 220, 225, 230, 235 and 270, 275, 280 and 285. The best beam to use for transmission or reception by the base station is identified from measurements of the uplink transmission from the mobile subscriber.

Conventionally, the allocation of radio resources to each beam of the grid at any given cell would be under the control of the local scheduler and there would be no cooperation between the schedulers at different cells. Therefore, as with FIG. 1, there exists a finite probability that mobiles could experience beam clash conditions, especially at the cell edge where mobiles would see strong interference from the adjacent cell. This could limit link throughput or cause blocking. The likelihood of beam clashes reduces with the number of beams per sector/cell. In practice, however, it is likely that no more than 3-4 beams per sector would be deployed and hence, the probability of random beam clash remains significant.

In the embodiment of FIG. 2, beams 230 and 285 are shown to be simultaneously illuminated under the internal scheduling process of each base station. As such, subscribers A 231 and B 286 will be simultaneously served. In particular, the schedulers ensure that adjacent beams, for example, beams 230 and 275 are not simultaneously illuminated, so that subscribers A 231 and C 276, which are much more proximate, are not simultaneously served.

Thus, the probability of beam clash may be minimized by using an appropriate pattern for the beam allocation sequences at the different cells in the network. At any given scheduling instant, only one beam will be transmitting in each sector. Accordingly, it is then straightforward to calculate by computer simulation the SNIR for every beam combination of any one beam in the serving sector together with the simultaneously illuminated beam from every interfering sector of the network. Results from such computer simulations are described below.

The minimization of beam clashes makes use of fixed “quasi-orthogonal” beam allocation sequences in the scheduler of each base station, as opposed to “on-the-fly” beam collision avoidance. Such latter method would involve instantaneous communication between base stations and cooperation between their respective schedulers, and would introduce considerable end-to-end system latency, complexity and expense in comparison to the present invention.

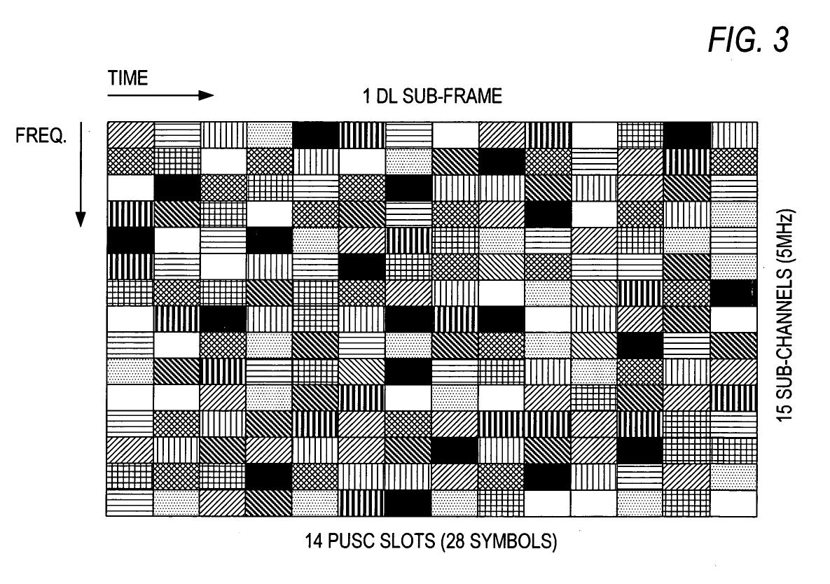

Turning now to FIG. 3, there is shown a prior art diagram showing how the internal scheduler would allocate frequency and time resources in the case of a conventional sector with a switched multibeam configuration, but in the absence of the inventive system. In this example, OFDMA/PUSC (partially utilized sub-carrier) resource partitioning has been assumed and resource blocks similarly cross-hatched are assumed to be associated with the same subscriber. The figure shows a random subscriber assignment in time.

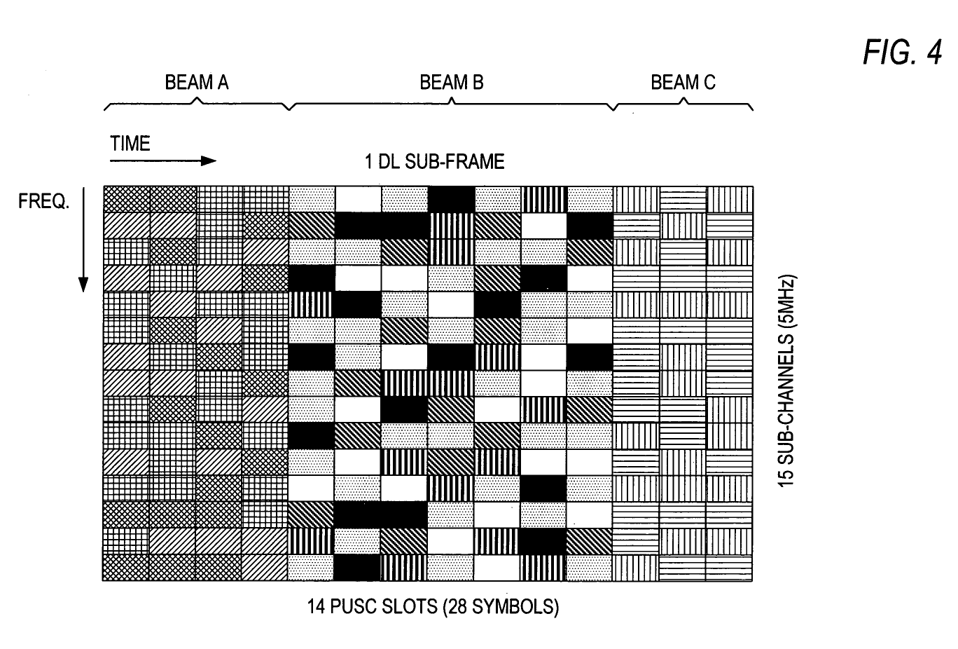

By contrast, FIG. 4 shows a comparable diagram showing how the internal scheduler would allocate frequency and time resources in the present invention, according to the best beam associated with each subscriber. The figure shows subscribers are clustered in time, according to the best beam, which serves as a rough proxy for the spatial location of each mobile, sufficient for these purposes.

Preferably, the time interval allocated to each beam may vary dynamically according to the traffic associated with such beam. Those having ordinary skill in this art will appreciate that the introduction of such a dynamic allocation scheme to the scheduler will ease bandwidth congestion, but at the cost of increasing, to some extent, the probability of beam clash from 0 (in the case of no overlap between adjacent beams) to some finite probability, which will in any event still be below the probability of beam clash in conventional systems.

While an optimal configuration has not yet been determined, simulation results suggest that significant SNIR performance gains may be achieved by appropriate scheduling protocols, including the performance gains otherwise achievable only through frequency reuse, but without the attendant spectral capacity compromise.

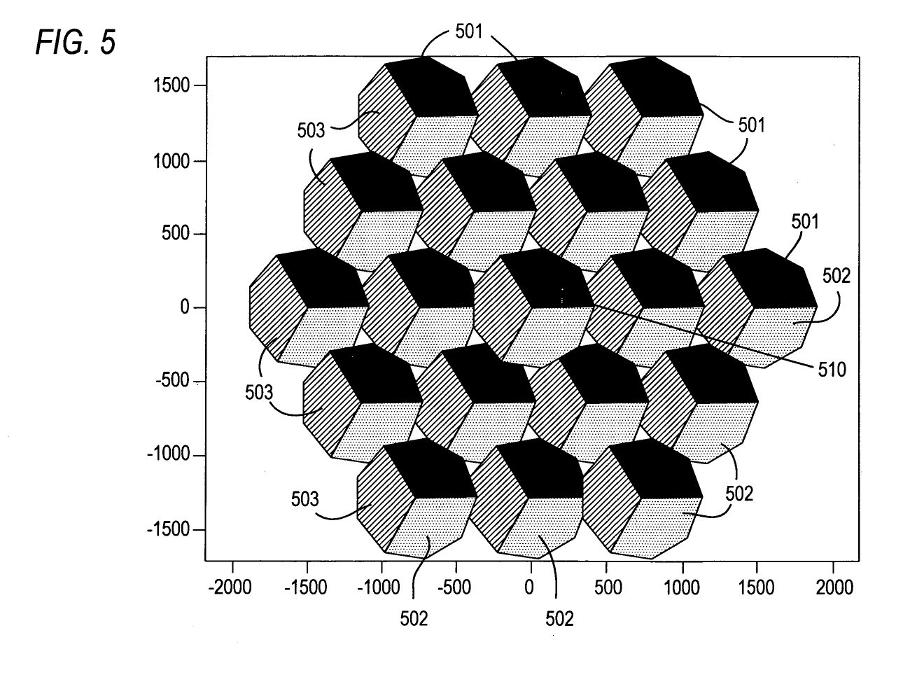

As a baseline system for comparison of performance as measured by cumulative distribution functions (CDF), we consider a nominal N=⅓ sequential frequency reuse pattern system, shown in FIG. 5. In such a system, each of the sectors is oriented in one of three directions (3 sectors per cell in a regular hexagonal grid) and all sectors having a common orientation 501, 502, 503 are allocated a common frequency sub-set, which comprises ⅓ of the frequency bandwidth available to the network. The term “sequential pattern” refers to the fact that a regular reuse pattern has been used at all cells in the network.

The simulation modelled the RF network geometry for the identified 57 sectors corresponding to 19 cells, including a large number of trials (in this case 3,000) wherein mobiles were dropped at randomized locations within a selected interior sector 510, and the mean long-term averaged SISO (single input single output) SNIR returned by each mobile served by the selected sector 510 was computed. This value includes representative path loss conditions and allowance for log normal shadow fading.

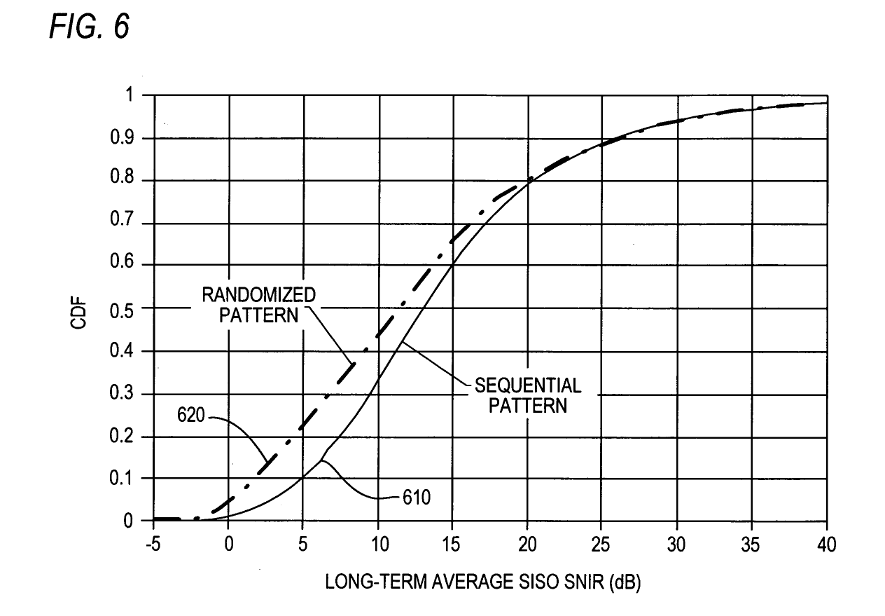

The resulting CDF for the above-described sequentially fixed reuse pattern simulation 610 is shown in FIG. 6. It shows the number of subscribers which have a poorer SNIR performance than indicated on the abscissa. It can be seen that such baseline system achieves a CDF value of 10% at a 5 dB SNIR threshold. This means that the network coverage is such that 90% of mobiles achieve 5 dB or better.

This performance shows a marked improvement over that of a randomised pattern 620, in which each sector is randomly assigned one of the three frequency sub-sets, of about 3 dB at the bottom end. This improvement reflects the fact that the randomized pattern does not obtain the benefit of frequency reuse because the sectors having a common frequency subset are not all commonly oriented.

Armed with such baseline performance, a number of potential implementations of scheduling protocols using directional beam antennas within the system may now be evaluated. The use of such antennas is motivated primarily by improved spectral efficiency. The aim is for a multibeam design able to operate effectively at a full load or unity frequency reuse (N= 1/1), thus achieving an intrinsic 3-fold improvement in spectral efficiency over the baseline system, while at the same time providing a similar SNIR distribution.

Typical performance targets for a directional beam system may be a 2× improvement in aggregate capacity combined with a 5× improvement in 90% coverage over the baseline system. This performance target would apply post-scheduler and is therefore difficult to enumerate as a simple improvement factor to the SNIR CDF. For simplicity, it is assumed that the multibeam system operates at a nominal N= 1/1 frequency reuse and achieves an SNIR distribution which is reasonably close to the sectored baseline result.

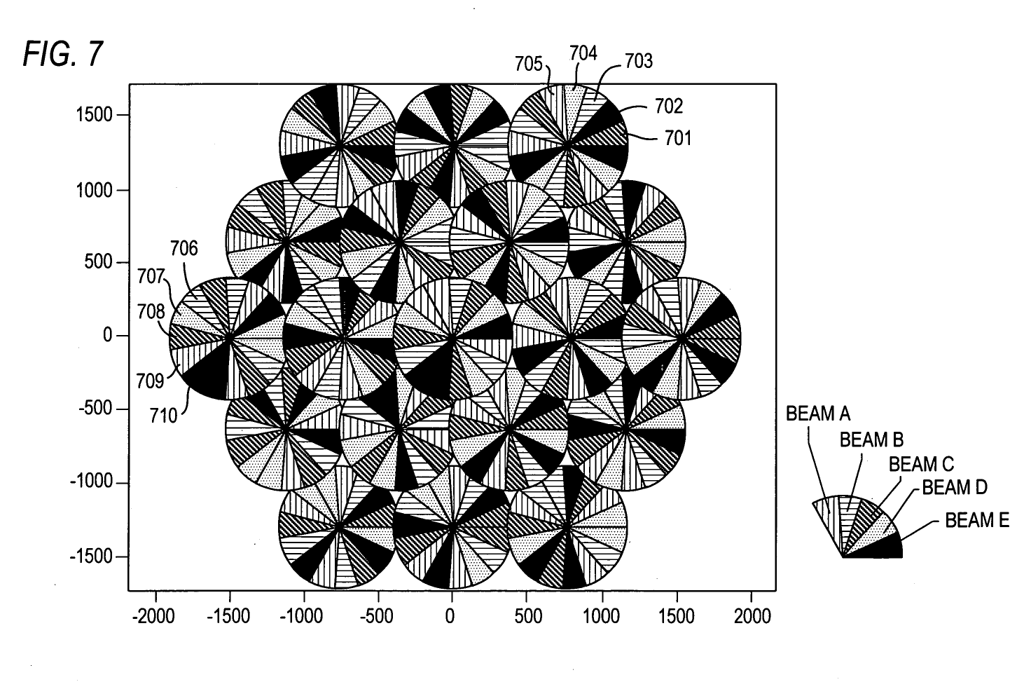

The first scheduling protocol is shown in FIG. 7. Here, each of the sectors 501, 502, 503 shown in FIG. 5 have been assigned the entire frequency spectrum allocated to the network (i.e. full load or unity frequency reuse N= 1/1) and 5 narrowband fixed overlapping beams have been distributed across the sector area. The beam set is formed for a 4-column, ½ wavelength spaced antenna array with no space tapering and an equal beam point-direction spacing of 24°.

For example, sector 501 in the top right-most sector is provided coverage by beams 701-705, sector 502 in the bottom right-most sector is provided coverage by beams 711-715 and sector 503 in the left-most sector of the third row is provided coverage by beams 706-710.

The cross-hatching of each beam corresponds to a different time interval to which the beam is assigned. The division of the frame into a number of “beam zones” will have some impact in the scheduling gains. However, this is not thought to be significant when there are a moderate number of active mobiles uniformly distributed across the coverage area of each cell.

As can be seen from the cross-hatching pattern shown in FIG. 7, there is a randomized allocation of time intervals to beams. This represents the intrinsic beamforming performance with “dumb” beam scheduling with no scheduler optimizations. Any SNIR gains are attributable to the narrow beam aspects of the antenna.

From the target sector's point of view, the beam selection in all the interfering sectors is essentially random. Nothing is in place to stop beam clashes, with adjacent interfering sectors being free to steer their beams toward the target mobile.

Thus, the protocol represented by FIG. 7 may be considered to be a worst-case scenario, as very little is being done in terms of obviating beam clash.

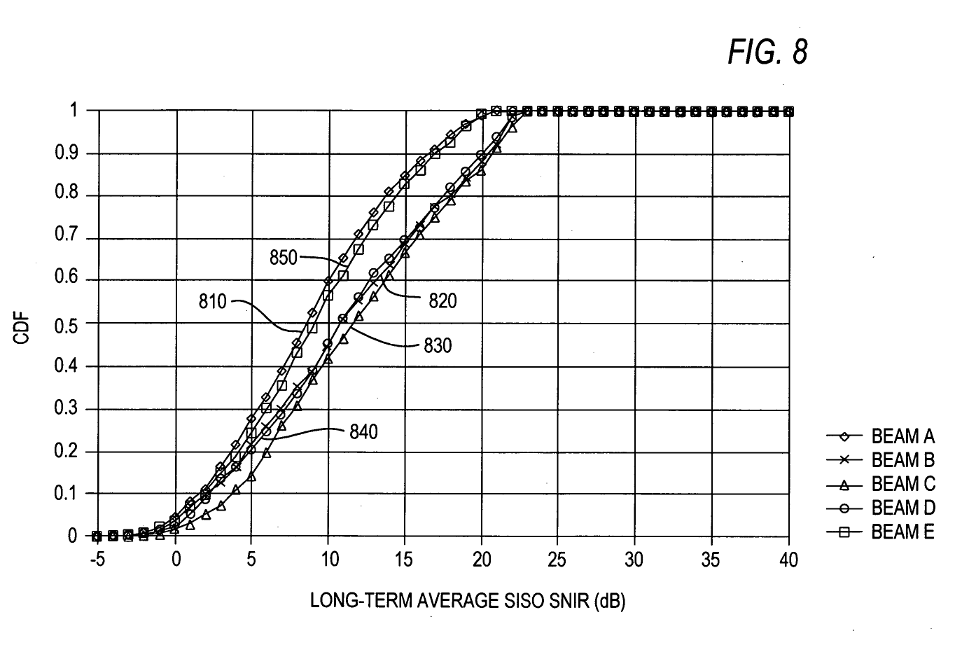

The performance of such a worst-case scheduling protocol is shown in FIG. 8 on a beam by beam basis for the selected central target sector 510. It may be seen that certain beams, namely the outer beams A 810 and E 850, show relatively degraded performance as compared to the remaining beams B 820, C 830 and D 840. This is due to the sector pattern envelope, which is no different from the baseline case.

Nevertheless, it is evident that in terms of SNIR, the beamforming system with completely random beam scheduling, running at full load or unity frequency reuse (N= 1/1) performs worse than the baseline sectorized system running at a frequency reuse of N= 1/3 shown in FIGS. 5 and 6. At the 90% coverage point, there is a 3 dB performance degradation.

While there is nevertheless improved performance having regard to the 3-fold frequency reuse factor gain, in coverage terms, the beamforming system with random beam scheduling performs poorly, with an increased number of subscribers failing to achieve sufficient SNIR to permit any data throughput whatsoever.

It appears that the possibility of beam clashes in such system sufficiently degrades the SNIR performance that cell-edge subscribers may be adversely affected.

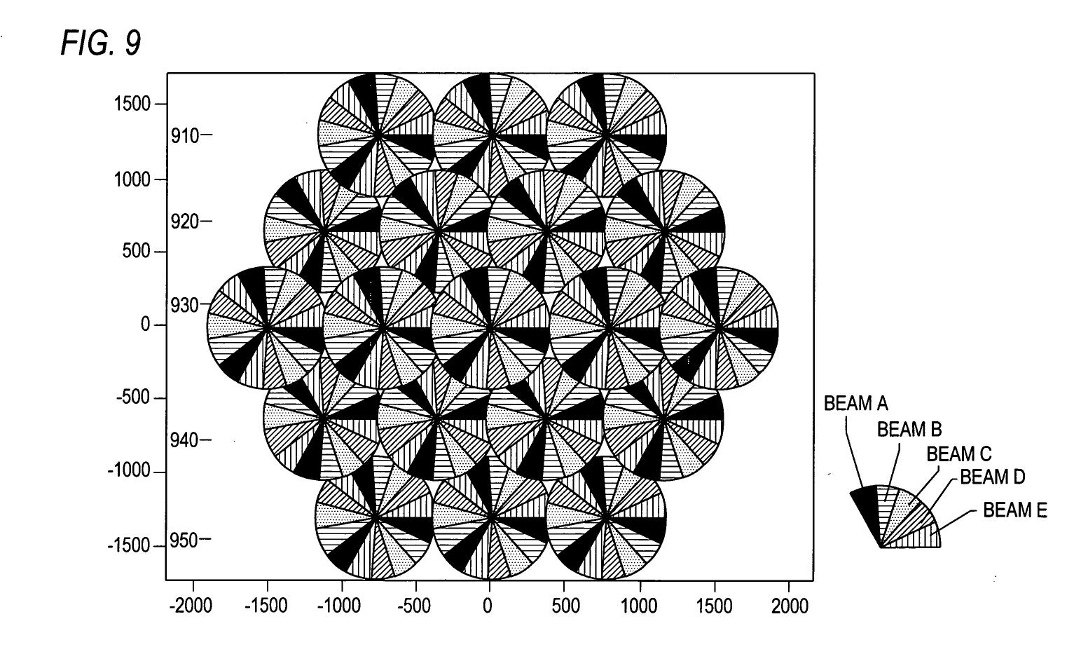

Turning now to FIG. 9, there is shown a fixed reuse scheme that attempts to reduce the probability of beam clashes by taking advantage of a coordinated scheduling protocol in accordance with the present invention, to achieve both capacity and coverage improvement. The illustrated exemplary protocol is symmetric in that performance in the selected central target sector 510 will be statistically equivalent to all sectors in the network.

The scheme itself consists of a common sequential scheme for cells in rows 910, 930 and 950, with alternating rows 920, 940 having a reversed sequential scheme. Nevertheless, even with such a simple scheme, the combination of scheduling and beamforming provides reasonable gains.

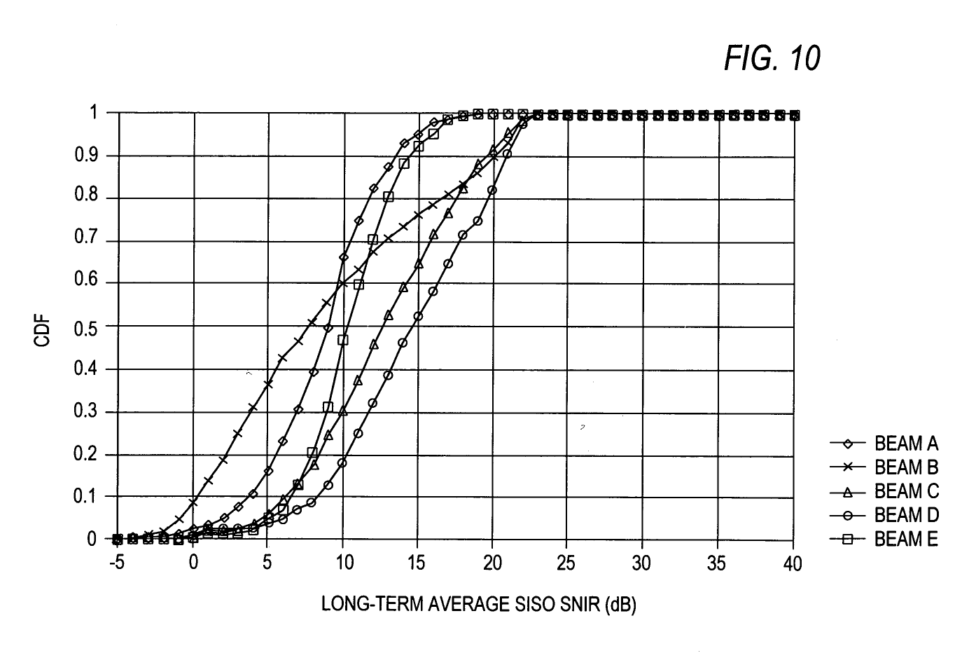

Turning to FIG. 10, the performance CDF indicates that considerable SNIR gain is achieved for all but one of the beams at the 90% coverage point (measured at the 10% CDF threshold value on the graph) over the non-scheduled (or randomly scheduled) scheme shown in FIG. 7. Even so, there is no inter-base station communication. Rather, each base station operates on a pre-set beam allocation pattern and this would have no impact on the existing standard, were it to be deployed in a WiMAX system.

Thus, FIG. 10 demonstrates that beamforming, in conjunction with predetermined inter-base cooperative scheduling in accordance with the present invention supports full load or unity frequency reuse (N= 1/1) with a cell-edge SNIR performance that approaches that of the N=⅓ baseline sectorized system shown in FIGS. 5 and 6.

Thus, significant capacity gains, following from the 3-fold increase in available spectral resource may be achieved without adversely impacting the cell-edge user. Indeed, throughput to the cell-edge user could be significantly increased if desired, by altering the fairness exponent of the scheduler, although with a concomitant reduction in overall aggregate capacity.

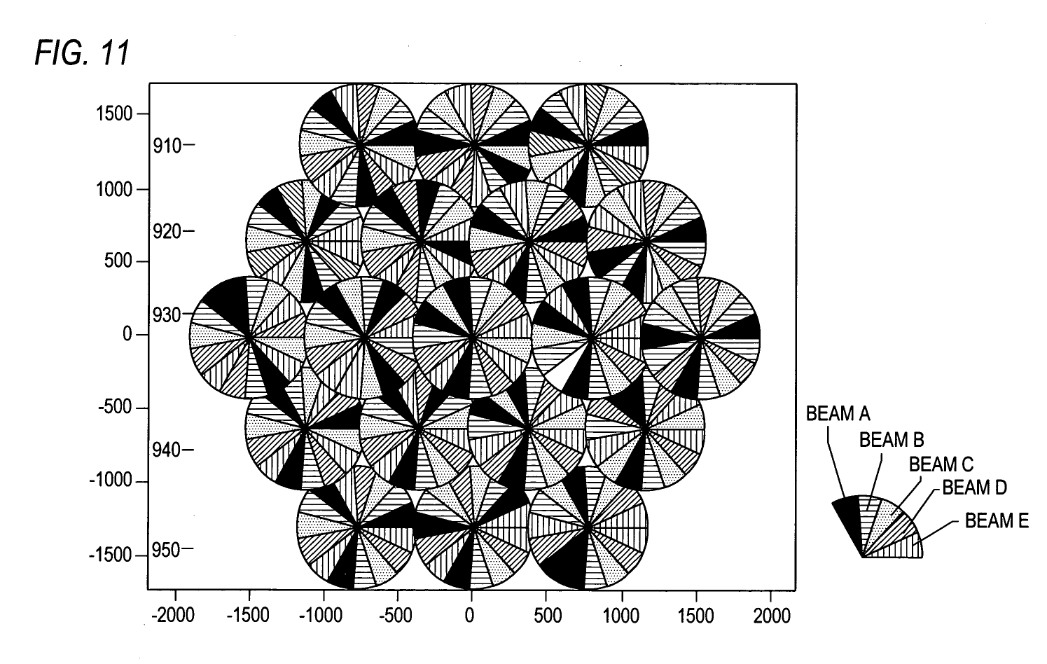

Turning now to FIG. 11, there is shown a fully optimized beam scheduling protocol for the selected central target sector 510. In this case, the beam allocations at every interfering sector have been tailored such that the SNIR performance in the target sector is optimized through an exhaustive search of all possibilities. As such, the exemplary protocol is non-symmetric, in that other sectors in the network will have different, less advantageous, statistical distributions of SNIR, whose performance is not considered.

Nevertheless, the optimized protocol for the target sector presumably represents an upper bound on coverage performance that may conceivably be experienced by application of the present invention.

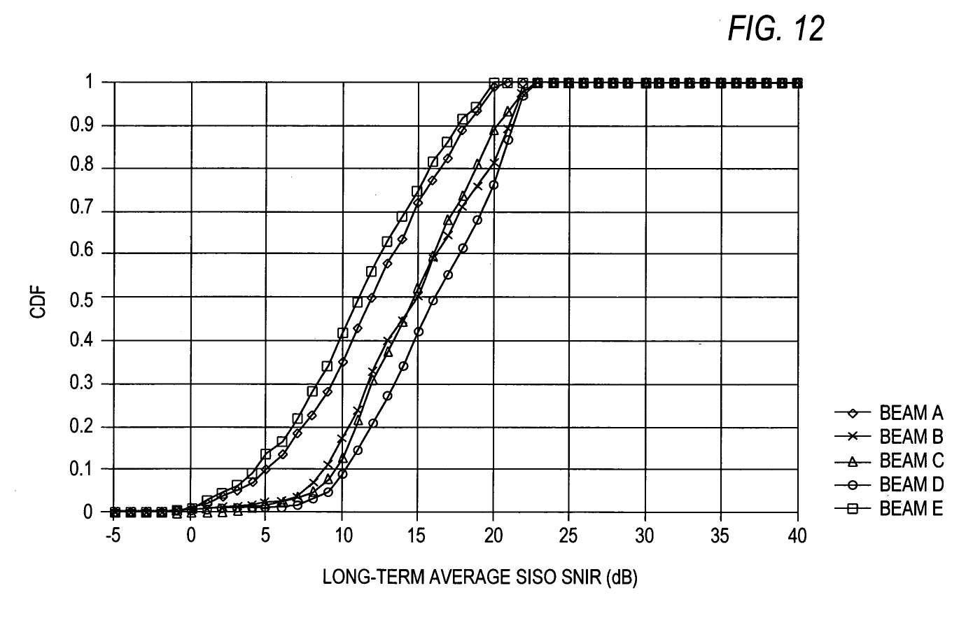

As is shown in FIG. 12, there is now a very substantial gain in cell-edge SNIR performance compared to the baseline protocol of FIGS. 5 and 6.

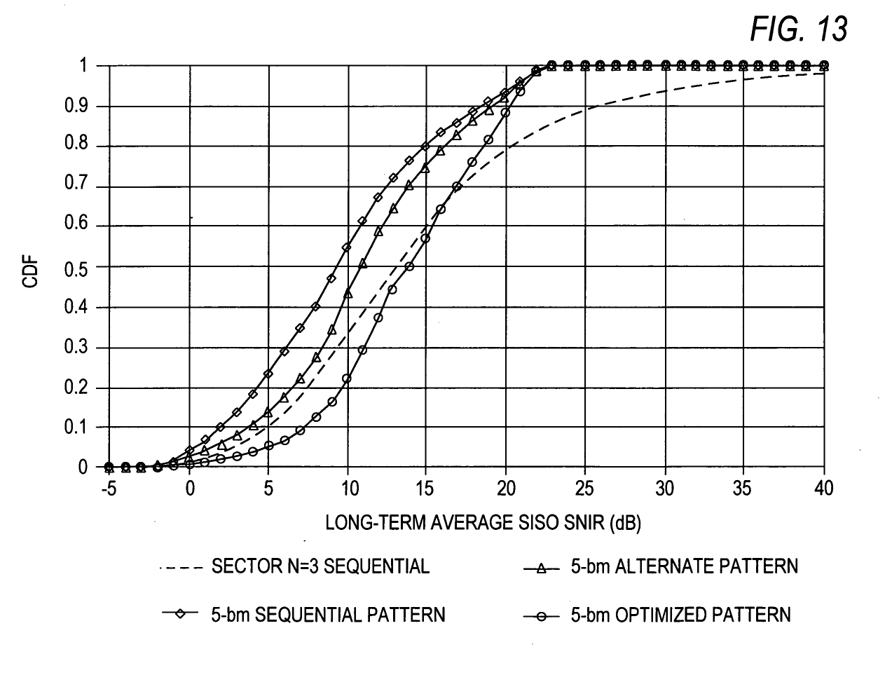

FIG. 13 shows the performance CDF for the baseline protocol of FIGS. 5 and 6, with the exemplary protocols in accordance with the present invention described in FIGS. 7 through 12, averaged across all 5 beams. Such composite patterns demonstrate more clearly that at the 90% coverage point, there is a 2.5 dB improvement, although, presumably at the expense of the performance CDF of other neighbouring sectors. Coupled with the 3-fold increase in available spectral resource due to the unity frequency reuse factor, such an arrangement would provide significant capacity gains and cell-edge user throughput gains.

While the use of regular hexagonal network layouts is generally accepted in the art for simulation purposes, it is unlikely that such an idealized layout will exist in a real-life network implementation.

Rather, any optimized beam scheduling protocol would conceivably be uncovered through the use of network modelling tools in conjunction with field measurements and observation of operational metrics relating to actual-user SNIR criteria and achievements, such as is well understood by those having ordinary skill in this art.

Hitherto, the emphasis has been on improving the performance of a mobile subscriber at the cell edge boundary between sectors of adjacent cells. Those having ordinary skill in this art will appreciate that the present invention may also provide performance improvements for mobile subscribers lying in the cusp area between adjacent sectors of a common cell.

Such performance improvement was hinted at by the apparent performance improvement experienced by interior beams B 820, C 830 and D 840 in FIG. 8 as compared to the outer beams A 810 and E 850. This improvement appears to be related to the fact that even in the randomized protocol described, the allocation of subscribers to time intervals corresponding to different best beams ensured that there would be no beam clashes between adjacent beams for subscribers that may lie in the cusp region between such beams.

This demonstrates that when running at the most aggressive frequency reuse factor (N= 1/1), it is not only adjacent cells that cause interference but also adjacent sectors within the serving cell, at least on the forward link.

Indeed, while the preceding discussion applies equally to adjacent sector interference as it does to other cell interference (typically at the cell edge), a distinct aspect of the present invention has application primarily to adjacent sector interference. This aspect arises in circumstances where inter-base station cooperative scheduling is not desired, for example, where an operator is unwilling to submit to reuse planning.

In such circumstance, intra-cell interference avoidance may still be implemented at each individual base station with zero planning overhead for the operator. This is accomplished by cooperative scheduling between sectors at each base station.

However, rather than using a predetermined beam sequence/allocation strategy that is set up a priori by the operator, the adjacent sectors may implement an automatic beam clash avoidance scheme.

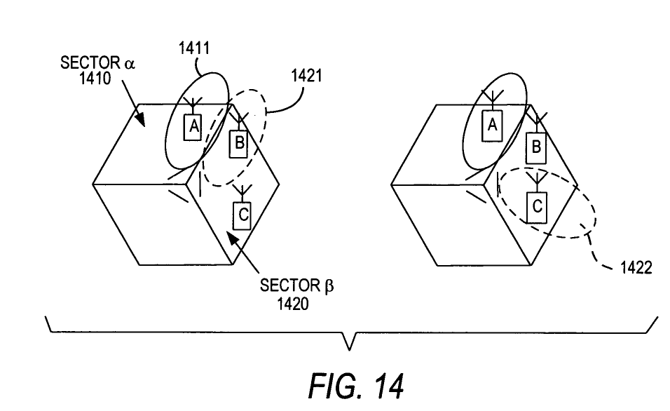

Turning to FIG. 14 such an avoidance scheme is demonstrated. It involves recognition when an edge beam 1411 is illuminated by a sector (e.g. sector α 1410) in a particular time-frequency segment of the downlink subframe, so that the corresponding sector (e.g. sector β 1420) does not simultaneously illuminate its corresponding edge beam 1421 but rather illuminates a different beam 1422.

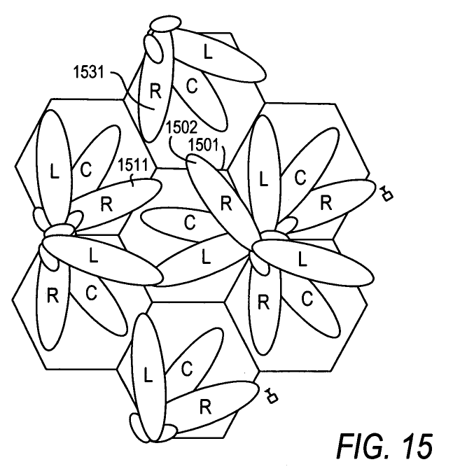

A simplistic example of the foregoing may be modelled as in FIG. 15, in which each sector is represented by a fixed three beam system. Here, each beam is illuminated in an order across the sector azimuthal range (for example, L, C, R, L, C, R, etc.). As previously discussed, this scheduling is superimposed on other scheduling protocols such as Equal Throughput or Proportional Fair Scheduling.

Those having ordinary skill in the art will appreciate that such an intra-cell interference avoidance scheme will manifestly not assist with inter-cell cell-edge performance. Indeed, as FIG. 15 shows, at a given time interval, an outlying subscriber near the cell edge, for example, subscriber 1502, may be subject to multiple cell clashes from a plurality of simultaneous beams 1501, 1511, 1521.

Those having ordinary skill in this art will also appreciate that although the foregoing discussion has been in the context of fixed multibeam or grid of beams adaptive beamforming implementations, the application of the present invention may be extended to more agile adaptive beamforming approaches.

For example, the present invention may be extended to a system employing individually tailored steered beams, by dividing each sector into a plurality of azimuthal zones, evocative of the fixed beam arrangement discussed previously.

Then, each user has a beam individually steered to it, maximizing antenna pattern gain, but the scheduler implements a protocol in which such beams are only scheduled in the segments of the TDD frame corresponding to the azimuthal zone it occupies. In effect, the scheduling protocol allocates time intervals according to the direction of arrival (DoA) of the mobile subscriber.

In this way, beam clashes may be avoided to approximately the same extent as for fixed multibeam scenarios, with roughly equivalent performance gains over conventional individually tailored steered beam systems, which in themselves may import a coverage gain over fixed multibeam systems.

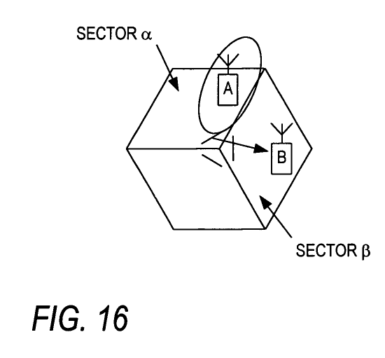

Similarly, the present invention may be extended to a system incorporating spatial null steering in the direction of an adjacent-sector interferer, such as is shown in exemplary fashion in FIG. 16 in a manner well known to those having ordinary skill in this art.

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific integrated circuits), FPGAs (field-programmable gate arrays) or DSPs (digital signal processors).

Examples of such types of computers are the schedulers contained in each base station, suitable for implementing or performing the apparatus or methods of the invention. The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

What is claimed is:

1. A method of avoiding beam clashes at a mobile subscriber, between a desired directional beam emanating from a base station associated with the mobile subscriber, along which communications between the mobile subscriber and the associated base station extend, and an interfering directional beam, the method comprising the steps of:
a. allocating all communications between the associated base station and the mobile subscriber along the desired directional beam to a first time interval; and
b. allocating all communications along the interfering directional beam to a second time interval that is different from the first time interval.

2. A method of avoiding beam clashes according to claim 1, wherein the first and second time intervals occur at different times in a downlink sub-frame period.

3. A method of avoiding beam clashes according to claim 1, wherein the first and second time intervals occur at different times in an uplink sub-frame period.

4. A method of avoiding beam clashes according to claim 1, wherein the desired directional beam and the interfering directional beam transmit and receive signals which share the same frequency bandwidth.

5. A method of avoiding beam clashes according to claim 1, wherein steps a. and b. are superimposed over an underlying scheduling protocol.

6. A method of avoiding beam clashes according to claim 1, wherein step a. comprises allocating all communications by the associated base station to different time intervals according to the directional beam therefrom along which they are made

7. A method of avoiding beam clashes according to claim 1, wherein the interfering directional beam emanates from an interfering base station.

8. A method of avoiding beam clashes according to claim 7, wherein step b. comprises allocating all communications by the interfering base station to different time intervals according to the directional beam therefrom along which they are made.

9. A method of avoiding beam clashes according to claim 7, wherein steps a. and b. occur in the absence of coordinating communications between the associated base station and the interfering base station.

10. A method of avoiding beam clashes according to claim 1, wherein the desired directional beam and the interfering directional beam emanate from a common sector of the associated base station.

11. A method of avoiding beam clashes according to claim 1, wherein the desired directional beam and the interfering directional beam emanate from different sectors of the associated base station.

12. A method of avoiding beam clashes according to claim 1, wherein the desired directional beam is a fixed beam.

13. A method of avoiding beam clashes according to claim 1, wherein the desired directional beam is a steered agile beam.

14. A method of avoiding beam clashes according to claim 13, wherein step a. comprises allocating the desired directional beam to a corresponding one of a plurality of azimuthal zones of a sector from which the desired directional beam emanates, each of the plurality of azimuthal zones having an associated time interval.

15. A method of avoiding beam clashes according to claim 11 wherein the desired directional beam comprises a spatial null directed towards an interfering subscriber being served in a different sector.

16. A system for avoiding beam clashes at a mobile subscriber, between a desired directional beam and an interfering directional beam, the system comprising:
a base station associated with the mobile subscriber, for generating a plurality of directional beams across a desired coverage area of the associated base station, including the desired directional beam, along which communications with the mobile subscriber extend, the associated base station comprising a desired beam scheduler for allocating all communications involving the associated base station along each of the plurality of directional beams to a corresponding time interval,
wherein all communications between the associated base station and the mobile subscriber along the desired directional beam occurs during a first time interval and all communications along the interfering directional beam occurs during a second time interval that is different from the first time interval.

17. A system according to claim 16, wherein the interfering directional beam emanates from the associated base station and extends across the desired coverage area thereof and wherein the desired beam scheduler allocates all communications involving the associated base station along the interfering directional beam to the second time interval.

18. A system according to claim 16, wherein the associated base station generates a second plurality of directional beams including the interfering directional beam across an interfering coverage area thereof that is different from the desired coverage area, the associated base station comprising an interfering beam scheduler for allocating all communications involving the associated base station along each of the second plurality of directional beams to a corresponding time interval including allocating all communications along the interfering directional beam to the second time interval.

19. A system according to claim 16, further comprising an interfering base station for generating an interfering plurality of directional beams including the interfering directional beam across an interfering coverage area of the interfering base station, the interfering base station comprising an interfering beam scheduler for allocating all communications involving the interfering base station along each of the interfering plurality of directional beams to a corresponding time interval, including allocating all communications along the interfering directional beam to the second time interval.

20. A system according to claim 16, wherein the desired directional beam and the interfering directional beam transmit and receive signals to mobile subscribers which share the same frequency bandwidth.

21. A system according to claim 16, wherein the desired beam scheduler superimposes its allocation of communications over an underlying scheduling protocol.

22. A system according to claim 16, wherein the plurality of directional beams are fixed beams spread out across the desired coverage area.

23. A system according to claim 16, wherein the plurality of directional beams are steered agile beams extending in an azimuthal direction each corresponding to at least one mobile subscriber.

24. A system according to claim 23, wherein the desired beam scheduler allocates each of the plurality of directional beams to a corresponding one of a plurality of azimuthal zones of the desired coverage area, each of the plurality of azimuthal zones having an associated time interval.

25. A scheduler operatively coupled to a base station adapted for communicating with a mobile subscriber, the scheduler for allocating all communications between the base station and the mobile subscriber along a desired directional beam emanating from the base station to a first time interval,
whereby the communications between the mobile subscriber and the base station along the desired directional beam will be free from interference with communications emanating along an interfering directional beam which are restricted to a second time interval that is different from the first time interval.

26. A computer-readable medium in a processor operatively coupled to a base station adapted for communicating with a mobile subscriber, the medium having stored thereon, computer-readable and computer-executable instructions which, when executed by the processor, cause the processor to allocate all communications between the base station and the mobile subscriber along a desired directional beam emanating from the base station to a first time interval,
whereby the communications between the mobile subscriber and the base station along the desired directional beam will be free from interference with communications emanating along an interfering directional beam which are restricted to a second time interval that is different from the first time interval.
